(19) United States
(12) Patent Application Publication
(10) Pub. No.: US 2024/0199764 A1
(43) Pub. Date: Jun. 20, 2024

(54) SYSTEM AND METHOD FOR PRODUCING MICROCRYSTALLINE CELLULOSE

(71) Applicant: ANDRITZ OY, Helsinki (FI)

(72) Inventors: Kari VANHATALO, Espoo (FI); Hannu RÅMARK, Kotka (FI); Sonja PÄÄRNILÄ, Helsinki (FI); Kari PELTONEN, Kotka (FI)

(21) Appl. No.: 18/556,879

(22) PCT Filed: Apr. 27, 2022
(86) PCT No.: PCT/FI2022/050275

§ 371 Date: Oct. 23, 2023

(30) Foreign Application Priority Data
Apr. 30, 2021 (FI) 20215507

(51) Int. Cl. C08B 15/02

(52) U.S. Cl. CPC C08B 15/02

(57) ABSTRACT

A method for preparing microcrystalline cellulose (MCC) including: acid hydrolysis of a pulp mixture in at least one reactor to obtain a hydrolyzed process mixture, and mixing the hydrolyzed process mixture to form the MCC in the at least one reactor during the acid hydrolysis, wherein the mixing is performed with an energy dissipation around 1.0×10⁶ W/m³ to 15.0×10⁶ W/m³ and wherein a period of the mixing is in a range of 5 s to 180 s, and the MCC has an a to d ratio less than 6.0.

### TECHNICAL FIELD

The present disclosure relates to a system for producing microcrystalline cellulose (MCC). The present disclosure further relates to a system providing a new way for producing MCC by using mixing in a two stage reactor system enabling adjustment of product average particle size and particle size distribution.

### BACKGROUND

Microcrystalline cellulose (MCC) is a cellulose product having particle-like physical characteristics which are totally different than those of the raw material it is produced from, chemical pulp. Chemical pulp has fiber-like structure meaning a high length/thickness ratio, in the MCC manufacturing process it is transformed to a particle-like product using an acid hydrolysis process.

The intensity of the hydrolysis process affects the product properties. The more chemical used, the longer residence time of hydrolyzed material in a reactor, or the higher consistency of reaction slurry, the higher the hydrolysis intensity. This means that by changing intensity of acid hydrolysis in MCC manufacturing process, various kinds of MCC products can be produced.

It is a well-known fact in chemical engineering science that mass transfer affects the efficiency of chemical reactions. If mass transfer is insufficient, concentration gradients are formed leading to a decrease of the reaction rate. This can happen e.g. in an acid hydrolysis process when MCC is manufactured.

Mixing phenomena level out concentration gradients inside a reactor or reactors by converting heterogenous material mixtures to homogenous form. This can lead to an increase in the reaction rate, e.g. in MCC acid hydrolysis, meaning more efficient production process. Because mixing is a physical unit process it will also affect the product by mechanical means.

So, in MCC manufacturing, product properties are the result of a combination of several factors (chemical charge, process concentration, time, temperature, mass transfer, and physical stress).

U.S. Pat. No. 2,978,446 discloses a method for manufacturing MCC. In said method, acid is added to the reactor in one portion and reactor is started. No mixing during the hydrolysis reaction is mentioned. After the hydrolysis, the product is modified using strong mechanical mixing/shear lasting 1 h to create a viscous gel. U.S. Pat. No. 7,037,405 discloses a method of producing MCC using acids, it does not mention mixing during the acid hydrolysis process. Acid is added to the reactor in one portion. The patent teaches using a harsh mechanical refiner after hydrolysis to produce very small MCC particles having particle size range 1.0-10.0 μm. WO 02/057540 discloses a method of producing MCC using pulp material that has not been dried and mixing the reaction slurry during the hydrolysis reaction. The acid is added to reactor in one portion. US patent 2012/0135505 discloses an MCC manufacturing process where compressed cellulose raw material is hydrolyzed using acid(s). The reaction slurry is stirred during the hydrolysis procedure and the acid added to the reactor in one portion. The patent does not teach effect of mixing on the end product. U.S. Pat. No. 4,391,973 discloses an MCC process where cellulose raw material is hydrolyzed using acid(s) and the reaction mixture is stirred during the hydrolysis process, it does not mention the effect of mixing on the end product. WO 2019/095024 discloses making MCC using 2 separate reactors. Between the reactors the pressure is reduced to atmospheric pressure and washing of intermediate product is performed. Acid is added to reactor 1 and to reactor 2. No mixing mentioned during hydrolysis process.

None of the known methods show the fact that by using very short mixing during, or after hydrolysis, product properties can be adjusted. Neither do any of the known MCC manufacturing methods show split acid adding combination to hydrolysis system. By performing the hydrolysis process on the cellulose material in two stages, e.g. in a two reactor system and multiple acid additions in several places of the reactor system, the process efficiency is higher, as shown by Battista in experiments mild vs. harsh hydrolysis doing hydrolysis in two stages (Battista, O. A., Hydrolysis and crystallization of cellulose, IND ENG CHEM, vol. 42, No. 3, 502-507), resulting in increased yield.

In view of the known processes there is a need for a renewed method to produce MCC where the product properties can be varied using simple process solutions.

### SUMMARY

A method for producing microcrystalline cellulose (MCC) is disclosed. The method may comprise:
a. Acid hydrolysis of a pulp mixture in a reactor to obtain a hydrolyzed process mixture,
b. mixing the hydrolyzed process mixture to form MCC.

A system for preparing MCC is disclosed. The system may comprise at least one reactor.

A microcrystalline cellulose (MCC) obtainable by the disclosed method or system is disclosed.

### BRIEF DESCRIPTION OF THE DRAWINGS

The accompanying drawings, which are included to provide a further understanding of the embodiments and constitute a part of this specification, illustrate various embodiments. In the drawings:

FIG. 1 presents a schematic drawing of an embodiment of a system for producing MCC according to the present disclosure wherein the system comprises one reactor.

FIG. 2 presents a schematic drawing of an embodiment of a system for producing MCC according to the present disclosure wherein the system comprises two reactors.

FIG. 3 presents d-ratio values after mixing MCC1 using different rpm's and mixing times using a cutting-type mixer.

FIG. 4 presents particle size distribution of MCC1 before mixing.

FIG. 5 presents particle size distribution of MCC1 after 15s mixing using 15000 rpm.

FIG. 6 presents d-ratio values after mixing MCC2 using shear creating type mixer with rpm 5000 at temperature 80° C.

### DETAILED DESCRIPTION

A method for producing microcrystalline cellulose (MCC) is disclosed. The method may comprise:
b. Acid hydrolysis of a pulp mixture in a reactor to obtain a hydrolyzed process mixture, and
c. mixing the hydrolyzed process mixture to form MCC.

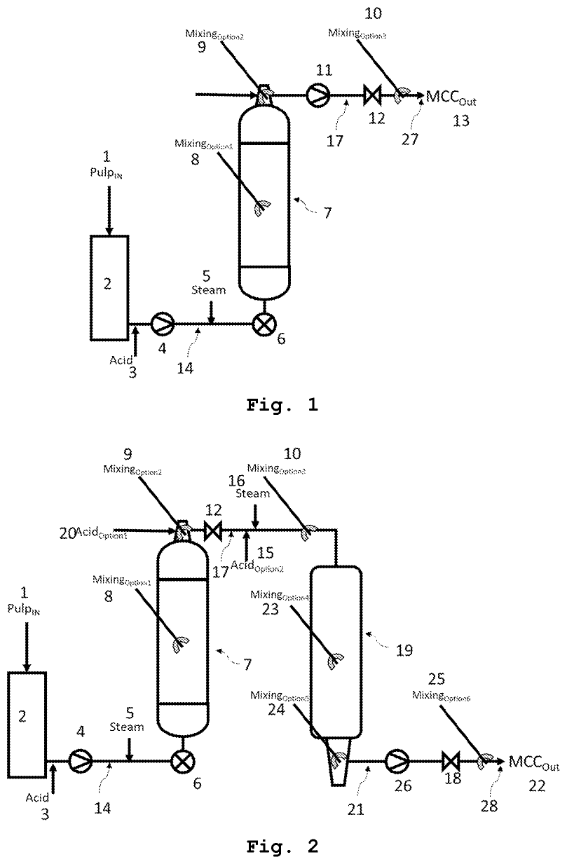

FIGS. 1 and 2 show exemplary implementations of the method using a single reactor system or a two-reactor system. In certain embodiments, mixing in this system can happen in one or several places and acid can be added to the system in one or several places.

In an initial stage of the process system, there is a pulp suspension which is used as raw material to manufacture microcrystalline cellulose (MCC). In one embodiment of the invention acid (3) used in MCC manufacturing can be added to the suspension in the initial stage before pulp enters a pumping vessel (2) or similar. The purpose of the pumping vessel is to balance the incoming pulp suspension flow before entering the sequential process stage. Alternatively, the pumping vessel can act as a mixing vessel if the addition of acid is performed before the suspension or pulp enters there.

The pulp used for the production of MCC may be any suitable type of bleached chemical pulp such as kraft pre-hydrolyzed pulp, kraft, sulfite pulp, semichemical pulp, mechanical pulp, nonwood pulp, recovered fibres, or any combination thereof. The pulp may be produced from hardwood, softwood, grasses, straws, wastepaper, bamboo, or any combination thereof.

In certain embodiments, the consistency of the pulp before introduction in the pumping vessel may be around 2-50 weight-%, around 3-45 weight-%, or around 5-30 weight-%.

In certain embodiments, the consistency of the pulp before introduction in the first reactor may be around 2-30 weight-%, around 3-25 weight-%, or around 5-20 weight-%, or around 8-15 weight-%. In one embodiment, the consistency of the pulp before introduction in the first reactor may be around 10 weight-%.

The pulp suspension (1) is fed from the pumping vessel (2) into the process line (14). A booster pump (4) is used to pump heated pulp suspension to hydrolysis reactor to maintain desired hydrolysis temperature and pressure. Process steam (5), which is used to heat the pulp to hydrolysis temperature, is fed into process line either before or after the booster pump. In one embodiment of the invention acid (3) used in MCC manufacturing process can added to process line before and/or after booster pump (4) in process line (14).

In one embodiment, process steam is used to heat the pulp suspension to around 80-185° C., or 90-175° C., or 100-165° C., or 120-160° C. In one embodiment, process steam is used to heat the pulp suspension to around 130-160° C.

In certain embodiments, the acid hydrolysis of pulp to form MCC may be performed according to the methods disclosed in patent applications WO 2011/145600 A1 or WO 2011/145601 A1.

The heated and acidified pulp suspension enters a 1^{st} reactor (7) where the cellulose in the pulp suspension is hydrolysed, meaning that it is depolymerized, i.e. the degree of polymerization (DP) is decreased. During the hydrolysis process, local concentration gradients can occur leading to a decrease in reactions speeds, i.e. the efficiency of the hydrolysis. In this kind of situation, the process does not work in an optimal state and does not produce a uniform product. To increase the homogeneity of material flow, remove concentration gradients, mix chemicals better, and to increase hydrolysis efficiency and product homogeneity, pulp suspension can be mixed inside the reactor.

In one embodiment, the mixing can happen any place inside the reactor before material flow out or in a pre-mixer (6) placed before the entry point of the reactor. At the pre-mixer and in the reactor the chemical pulp fiber is not yet hydrolyzed to microcrystalline cellulose and still has the chemical and physical characteristics of cellulose or pulp. This means the cellulose does not fulfill the definitions of microcrystalline cellulose defined by Food and Agriculture Organization of the United Nations.

In one embodiment, the mixing occurs in the reactor (7) using mixer (8). In one embodiment, the process mixture is mixed in the at least one reactor during the hydrolysis process. Mixing inside the reactor or reactors aids in producing a homogenous process mixture to improve the efficiency of the hydrolysis.

In one embodiment, the mixing can also occur at the output of the hydrolysis reactor or in process line after the output of reactor in mixer (9) or at the end of the process line (27) before removal of the MCC (13) in mixer (10).

In certain embodiments, the mixing in any of the aforementioned mixers may independently be described by one of the following alternatives:
1. If pulp suspension fibers have not been converted to microcrystalline cellulose (i.e. they have not been hydrolyzed) and are still at least partly in solid fiber form described by a high degree of polymerization, the mixing effect is the creation of a homogeneous mixture
2. If the hydrolysis process is already completed and the pulp has been hydrolyzed to microcrystalline cellulose a) in a chemical sense, but not necessarily in a physical sense (meaning that the pulp and/or MCC particles is still loosely attached or aggregated in fiber-like form), or b) in chemical and physical sense (meaning that the pulp is fully hydrolyzed), the effect of mixing is to disintegrate material into particle-like MCC and/or to adjust the properties of the final product such as particle size distribution.

In certain embodiments, the produced MCC may flow through process line (17) for further processing, e.g. washing, drying, and packing etc. In one embodiment, the hydrolyzed process mixture from the 1^{st} reactor is fed into a 2^{nd} reactor for further hydrolysis.

In certain embodiments, the material flow is lead to a 2^{nd} hydrolysis reactor after exiting the 1^{st} hydrolysis reactor. In one embodiment, a material flow that is still at least partially in fiber form is lead to a 2^{nd} hydrolysis reactor. In one embodiment, the process mixture is mixed at least once between the 1^{st} and the 2^{nd} reactor.

In certain embodiments, the hydrolysis process continues in the 2^{nd} hydrolysis reactor (19). The process and reactions of the 2^{nd} reactor is similar to that of the 1^{st} reactor described above.

During the hydrolysis process inside the 2^{nd} reactor, local concentration gradients can occur leading to a decrease in reactions speeds, i.e. the efficiency of the hydrolysis. In this kind of situation, the process does not work in an optimal state and does not produce a uniform product. To increase the homogeneity of material flow, remove concentration gradients, mix chemicals better, and to increase hydrolysis efficiency and product homogeneity, pulp suspension can be mixed inside the reactor.

In one embodiment, the mixing can happen in any place inside the reactor (19) using mixer (23) before material flow out. In the reactor the chemical pulp fiber s not yet hydrolyzed to microcrystalline cellulose and still has the chemical and physical characteristics of cellulose or pulp.

In certain embodiments, the mixing in any of the aforementioned mixers may independently be described by one of the following alternatives:
1. If pulp suspension fibers have not been converted to microcrystalline cellulose (i.e. they have not been hydrolyzed) and are still at least partly in solid fiber form described by a high degree of polymerization, the mixing effect is the creation of a homogeneous mixture
2. If the hydrolysis process is already completed and the pulp has been hydrolyzed to microcrystalline cellulose a) in a chemical sense, but not necessarily in a physical sense (meaning that the pulp and/or MCC particles is still loosely attached or aggregated in fiber-like form), or b) in chemical and physical sense (meaning that the pulp is fully hydrolyzed), the effect of mixing is to disintegrate material into particle-like MCC and/or to adjust the properties of the final product such as particle size distribution.

In one embodiment, the mixing can also be performed at the outflow of material from the 2^{nd} hydrolysis reactor using a mixer (24) or in the process line directly following the reactor using a mixer (25).

In certain embodiments, mixing of the pulp or process mixture may be carried out at one or more points of the process independently selected from prior to entering the 1^{st} reactor, the 1^{st} or 2^{nd} reactor, the flow out point of the 1^{st} or 2^{nd} reactor, at a point in the process line between the 1^{st} and 2^{nd} reactor, and/or the flow out point for the process.

In one embodiment, the process comprises a premixing of the process mixture or pulp prior to entering the 1^{st} reactor and one or more additional mixing steps at points of the process independently selected from the 1^{st} or 2^{nd} reactor, the flow out point of the 1^{st} or 2^{nd} reactor, at a point in the process line between the 1^{st} and 2^{nd} reactor, and/or the flow out point for the process.

In certain embodiments, acid may be added to the pulp or process mixture at one or more points of the process. In one embodiment, acid is added to the pulp or process mixture at least in process line (14) before or after booster pump (4). In certain embodiments, acid may be added to the process mixture in mixer (9) on leaving the 1^{st} reactor and/or prior to entering the 2^{nd} reactor (15). In one embodiment, acid is added to the process mixture between the 1^{st} and 2^{nd} reactor.

In one embodiment, process steam (5), which is used to heat the pulp to hydrolysis temperature, is fed into process line either before or after the booster pump. In one embodiment, additional process steam (16) is fed in the process line between the 1^{st} and 2^{nd} reactor.

In one embodiment, the added steam heats the process mixture to a temperature of around 80-185° C., or 90-175° C., or 100-165° C., or 120-160° C. In one embodiment, added steam is used to heat the pulp suspension to around 130-160° C.

Acid is added to the process mixture to hydrolyze the pulp into microcrystalline cellulose. In one embodiment, the acid is selected from the group consisting of mineral acids and organic acids. The acid used may be a mineral acid. In one embodiment, the acid is selected from the group consisting of sulphuric acid, hydrochloric acid, nitric acid, or any mixture thereof.

In one embodiment, acid is added to the process mixture in an amount that is 0.2-10 weight-% relative to the amount of solids.

High shear mixers used in mixing applications in pulp and paper industry have the ability to disrupt the fiber network that is formed when pulp consistency increases to the level 6-15%, more typically pulp is treated in consistency range 8-13%. For example, at 10% consistency the pulp forms groups of fibers, called flocs, the size of which is in the range 2-20 mm. A single fiber floc consists of tens of thousands of fibers. Disruption of the fiber network is essential for treating single fibers or micro flocs or to get chemical in contact with a fiber.

In one embodiment, mixing is performed with an energy dissipation of around 0.01-15.0×10⁶ W/m³. In certain embodiments, the mixing may be performed using low intensity 0.01-1.0×10⁶ W/m³ or high intensity 1.0-15.0×10⁶ W/m³. In one embodiment, mixing is performed with an energy dissipation of around 1.0-5.0×10⁶ W/m³.

In one embodiment, the mixing time is 0.1-180 s. In certain embodiments, the mixing time is 0.1-30.0 s, or 0.1-10.0 d, or 0.1-5.0 s.

In one embodiment, the process mixture is mixed thoroughly in the 1^{st} reactor to achieve complete hydrolysis of the cellulose in the pulp. Once the hydrolysis is completed, the hydrolyzed pulp is removed from the 1^{st} reactor and mixed briefly to homogenize the product MCC. In one embodiment, mixing is performed immediately on removing the hydrolyzed process mixture from the reactor. In one embodiment, additional mixings are performed after removing the process mixture from the reactor.

In certain embodiments, the MCC is formed in a semi-batch or continuous manner. In certain embodiments, the MCC is formed in a continuous manner.

In one embodiment, the hydrolyzed process mixture is removed from the 1^{st} reactor and mixed briefly to provide a thoroughly mixed intermediate process mixture that is fed into process a line (17). In one embodiment, the feeding of the intermediate process mixture is controlled by a valve (12).

In one embodiment, the process mixture may be mixed immediately prior to removing from the process line using a mixer (10, 25) to produce an MCC product with the desired characteristics.

After removal from the process line, the MCC product may be subjected to processing steps such as drying.

In certain embodiments, the flow of the process mixture in the process line and/or between the reactors may be controlled using pumps (4, 11, 26) and valves (12, 18).

The method of the present disclosure has the added utility that it enables production of MCC with small particle size and a narrow size distribution.

A system for producing MCC is also disclosed. In one embodiment, the system for producing MCC implements the method described above. The system for producing MCC comprises at least one reactor. In one embodiment, each reactor in the system comprises at least one mixer. In one embodiment, the system comprises a 1^{st} reactor in which a hydrolysis process is carried out. In certain embodiments, the system comprises at least a 1^{st} and a 2^{nd} reactor. Pulp is fed into the system from a pumping vessel (2) connected to the 1^{st} reactor by a process line (14).

In one embodiment, the process line comprises means for feeding acid into the pulp. In one embodiment, the process line comprises means for feeding acid into the pulp and means for feeding steam into the pulp. In one embodiment, the system comprises at least one pump for transporting the process mixture. In one embodiment, the process line also comprises a mixer (6) for mixing the pulp and acid to form a homogenous process mixture. In one embodiment, the system comprises at least one mixer outside the at least one reactors.

From the process line, the process mixture is fed into the 1^{st} reactor. After a pre-determined residence time in the 1^{st} reactor, the process mixture is removed from the 1^{st} reactor. In one embodiment, the process mixture is mixed briefly after removal from the 1^{st} reactor. In one embodiment, the system comprises at least one mixer at the exit of each of the at least one reactor.

In one embodiment, the process mixture removed from the 1^{st} reactor is mixed briefly immediately on removal from the 1^{st} reactor after to form a MCC composition which it is passed into a second process line (17). In certain embodiments, the second process line comprises a pump and/or a valve to control the flow of the MCC composition from the 1^{st} reactor. In one embodiment, the second process line comprises a mixer (10) that mixes the MCC composition before it is removed from the system (MCC_{OUT}, 13). In one embodiment, the system comprises at least one mixer in the process line.

In one embodiment, the system for producing MCC comprises a second reactor (19) connected to the 1^{st} reactor by a second process line (17). In certain embodiments, the second process line comprises a pump and/or a valve to control the flow of the process mixture from the 1^{st} reactor. In certain embodiments, the second process line comprises means for adding steam (16) to the process mixture to heat the process mixture before the 2^{nd} reactor. In one embodiment, the second process line comprises a means for adding acid (15) to the process mixture.

In one embodiment, acid is added to the process mixture between the 1^{st} and 2^{nd} reactor. In one embodiment, acid (20) can be added to the process mixture in connection with mixing the process mixture leaving the 1^{st} reactor. In one embodiment, the second process line comprises a valve (12) to control the flow of process mixture to the 2^{nd} reactor. In one embodiment, the second process line comprises a mixer (10) to briefly mix the process mixture immediately before entering the 2^{nd} reactor. In one embodiment, the system comprises a means for adding acid to the process mixture and/or a process line.

In the 2^{nd} reactor, the hydrolysis of the cellulose contained in the process mixture is completed to form a MCC composition. In one embodiment, the 2^{nd} reactor comprises a mixer (23) to ensure thorough mixing of the process mixture and complete hydrolysis of the cellulose. After a pre-determined residence time in the 2^{nd} reactor, the formed MCC composition is removed. In one embodiment, the MCC composition is mixed briefly immediately on removal from the 2^{nd} reactor and fed into a third process line (21). In one embodiment, the third process line comprises a mixer (25) that mixes the process mixture before it is removed from the system (22). In certain embodiments, the third process line comprises a pump and/or a valve to control the flow of MCC composition from the system.

In certain embodiments, the system is operated in a semi-batch or continuous manner. In certain embodiments, the system is operated in a continuous manner.

Once the MCC composition has been removed from the system, any final treatments may be applied to it. Non-limiting examples of such treatments are removing the water from the MCC composition, drying the MCC and/or sorting the MCC formed in the process or system by particle size.

The system of the present disclosure has the added utility that it enables production of MCC with small particle size and a narrow size distribution.

Using the method or system of the present disclosure it is possible to produce MCC with an even size distribution and small particle size. By adjusting the various mixing steps, it is possible to adjust the particle size of the produced MCC to a desired value and provide an MCC product with a narrow and even sized distribution.

MCC obtainable by the above method is disclosed herein. MCC obtainable by the above system using the above method is disclosed herein.

The MCC product formed using the method described herein or in the system described herein may have an average particle size of approximately 10-250 μm. In certain embodiments, the MCC has an average particle size of 20-200 μm, 25-150 μm, 30-100 μm, 35-75 μm.

The d10 of the MCC formed may be less than 30 μm, d50 may be less than 60 μm, and d90 may be less than 300 μm. In certain embodiments, the MCC has a d10 of less than 28 μm, or less than 26 μm, or less than 24 μm, or less than 22 μm, or less than 20 μm, a d50 of less than 55 μm, or less than 50 μm, or less than 45 μm, or less than 40 μm, or less than 35 μm, or less than 30 μm, and a d90 of less than 275 μm, or less than 250 μm, or less than 225 μm, or less than 200 μm, or less than 175 μm.

The d-ratio of the MCC formed may be in the range of 1.0-6.0. In certain embodiments, the d-ratio of the MCC is less than 6.0, or less than 5.5., or less than 5.0, or less than 4.5, or less than 4.0.

By varying the mixing speed and mixing time of the one or more mixings in the method described, it is possible to control both size and size distribution of the MCC formed in the process.

D-values (d10, d50, and d90) indicate how many percent (10%, 50%, or 90%) of the particle are over certain micrometer size. d-ratio means

$$\frac{d 90 - d 10}{d 50}$$

and it describes the wideness the of particle size distribution. The larger the d-ratio, the wider the size distribution. Usually sharp narrow particle size distributions are desired because it gives more precise properties to certain products.

In one embodiment, the MCC product of the disclosure may be use in pharmaceutical applications, cosmetics, food and beverage applications, or any combination thereof is further disclosed.

The MCC product described in the current specification has the added utility of having both a small particle size and a narrow size distribution compared to MCC produced with other methods.

The MCC composition described in the current specification has the added utility of having both a small particle size and a narrow size distribution compared to MCC produced with other methods.

### EXAMPLES

Reference will now be made in detail to various embodiments.

The description below discloses some embodiments in such a detail that a person skilled in the art is able to utilize the embodiments based on the disclosure. Not all steps or features of the embodiments are discussed in detail, as many of the steps or features will be obvious for the person skilled in the art based on this specification.

The following examples describe how mixing affects MCC product properties when it is done during or after the hydrolysis reaction. Definitions: d-values (d10, d50, and d90) indicate how many percent (10%, 50%, or 90%) of the particles are under certain micrometer size. d-ratio means

$$\frac{d 90 - d 10}{d 50}$$

and it describes wideness of particle size distribution. A larger the d-ratio indicates a wider size distribution. Usually sharp narrow particle size distributions are desired because it gives more precise properties to certain products.

### Example 1—Effect of Mixing on MCC Particle Size Distribution after Hydrolysis

Two microcrystalline cellulose products, MCC1 and MCC2, were prepared using hardwood base chemical pulp as raw material. Table 1 shows particle size d-values and d-ratio of these products.

TABLE 1
MCC properties (undried qualities, measured
using Malvern Mastersize 2000 equipment)

Product properties

| | d10 | d50 | d90 | |
|---|---|---|---|---|
| | (μm) | (μm) | (μm) | d-ratio |
| MCC1 | 16.0 | 55.2 | 359.7 | 6.2 |
| MCC2 | 15.4 | 50.8 | 280.5 | 5.2 |

Average particle size of MCC1 and MCC2 were 55.2 μm and 50.8 μm respectively. In the acid hydrolysis process, mild reaction conditions were used, so d90-values remained on a high level of 359.7 (MCC1) and 280.5 (MCC2). The d-ratios were: MCC1 6.2 and MCC2 5.2. So, both products had very wide particle size distribution. Both products were washed to neutral pH after hydrolysis.

Mixing experiments were performed on the MCC products in order to adjust the average particle size and especially the width of the particle size distribution to achieve much lower d-ratios.

High shear mixer was used for mixing MCC1 after the hydrolysis process, using 5% consistency. Mixer rpm value was changed and mixing times from 5 s to 635 s were used.

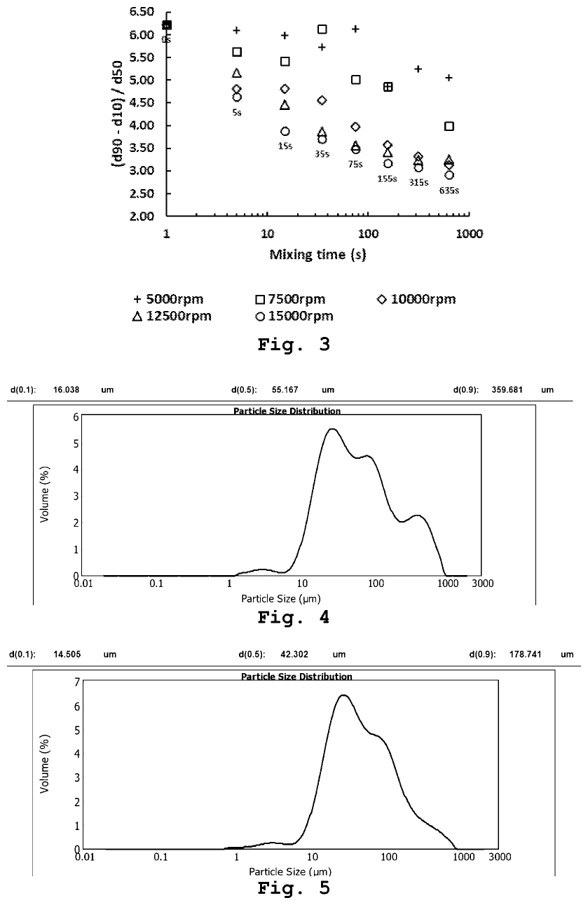

FIG. 3 presents d-ratio values after mixing MCC1 using different rpm's and mixing times. The mixer used was a cutting type mixer. FIG. 3 shows that even after short 5-15 second mixings, d-ratio values decrease around 40%. Using high rpm's decreases the MCC's d90-value from 359.7 μm to 230.9 μm after 5 seconds and to 178.7 μm after 15 seconds. This means that the portion of bigger particles decreases, d-ratio decreases and particle size distribution becomes narrower. FIG. 4 shows particle size distribution of MCC1 before mixing, and FIG. 5. after 15 seconds mixing.

The effect of mixing effect on size distribution is evident when using short mixing after hydrolysis. Short mixing removes distribution tri-modal shape converting it to more even distribution form. At the same time average particle size decreases from 55.2 μm to 42.3 μm.

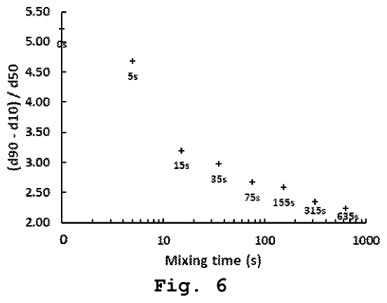

FIG. 6 shows the effect of mixing on MCC2. Used mixing consistency was 10%, MCC-water slurry was heated to 80° C. before mixing and 5000 rpm was used. Used mixer device was more shear creating mixer than in the previous case.

FIG. 6 shows that short 15 seconds time is enough to decrease d-ratio 5.2 to 3.2, which is almost 40% decrease. The d90-value, which depicts portion of bigger particle is 280.5 μm before mixing and after 15s it is decreased to 124.9 μm. At the same time average particle size is decreased from 50.8 μm to 34.9 μm.

### Example 2. Effect of Mixing During Hydrolysis on MCC Particle Size Distribution

In order to see the effect of mixing during acid hydrolysis in MCC manufacturing, a Lödige DVT5 reactor was used. The reactor was equipped with a heating jacket and steam was used as the heating medium. Lödige's reactor chamber diameter was 200 mm and height 230 mm making reactor volume 7.2 dm³. From the control unit it was possible to adjust the rpm's of the chopper (diameter 50 mm, max. rpm 3000, max. achievable peripheral speed 7.9 m/s) and mixing blades (diameter 190 mm, max. rpm 250, max. achievable peripheral speed 2.5 m/s). The chopper mixer was a fluidizing mixer used to provide high shear forces to the reaction slurry whereas the blades were intended for stirring. 10% reaction consistency, 1.5% sulfuric acid dosage, 150° C. temperature, 30 P-factor were used in MCC manufacturing. Table 2 shows resulted particle size of three test points.

TABLE 2
Results of MCC manufacturing when different mixing
intensities were used during acid hydrolysis.

| | | Mixing | Big | Chop- | | | | |
|---|---|---|---|---|---|---|---|---|
| Test- | P- | inten- | mixer* | per* | d10 | d50 | d90 | d- |
| point | factor | sity | (rpm) | (rpm) | (μm) | (μm) | (μm) | ratio |
| 1 | 30 | 1 | 49 | 0 | 10.3 | 29.5 | 162.1 | 5.1 |
| 2 | 30 | 2 | 124 | 1300 | 9.1 | 23.1 | 90.2 | 3.5 |
| 3 | 30 | 3 | 250 | 2900 | 8.6 | 21.7 | 76.0 | 3.1 |

It is seen from Table 2. that by increasing mixing intensity, the produced particle size is decreased, the particle size distribution becomes narrower, and the d-ratios decrease.

It is obvious to a person skilled in the art that with the advancement of technology, the basic idea may be implemented in various ways. The embodiments are thus not limited to the examples described above; instead they may vary within the scope of the claims.

The embodiments described hereinbefore may be used in any combination with each other. Several of the embodiments may be combined together to form a further embodiment. A method, a system, or a MCC composition, disclosed herein, may comprise at least one of the embodiments described hereinbefore. It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items. The term “comprising” is used in this specification to mean including the feature (s) or act (s) followed thereafter, without excluding the presence of one or more additional features or acts.

1.-13. (canceled)

14. A method for preparing microcrystalline cellulose (MCC) comprising:
acid hydrolysis of a pulp mixture in at least one reactor which generates a hydrolyzed process mixture, and
mixing the hydrolyzed process mixture to form the MCC in the at least one reactor during the acid hydrolysis,
wherein the mixing is performed with an energy dissipation in a range of 1.0×10⁶ Watts per cubic meter (W/m³) to 15.0×10⁶ W/m³,
wherein a period of the mixing is in a range of 5 seconds (s) to 180 s, and
wherein the MCC has a d-ratio no greater than 6.0.

15. The method of claim 14, wherein the mixing is performed immediately after removing the hydrolyzed process mixture from the at least reactor.

16. The method of claim 14, wherein the mixing includes mixing after removing the process mixture from the at least one reactor.

17. The method of claim 14, wherein the acid hydrolysis and the mixing are performed continuously.

18. The method of claim 14, further comprising transferring the hydrolyzed process mixture from a first reactor of the at least one reactor to a second reactor of the at least one reactor, wherein the acid hydrolysis is performed in the first reactor and in the second reactor.

19. The method of claim 18, further comprising adding acid to the hydrolyzed process mixture as the mixture is transferred from the first reactor to the second reactor.

20. The method according to claim 18, wherein the mixing includes mixing the hydrolyzed process mixture after the mixture is removed from the first reactor and before the mixture enters the second reactor.

21. The method of claim 18, wherein the mixing is mixing the hydrolyzed process mixture as the mixture is transferred from the first reactor to the second reactor.

22. The method of claim 18, wherein a first mixer is in the first reactor and a second reactor is in the second reactor, and
the mixing includes:
the first mixer mixing the hydrolyzed process mixture in the first reactor wherein the first mixer dissipates energy during the mixing in a range of 1.0×10⁶ W/m³ to 15.0×10⁶ W/m³, and
the second mixer mixing the hydrolyzed process mixture in the second reactor wherein the second mixer dissipates energy during the mixing in a range of 1.0×10⁶ W/m³ to 15.0×10⁶ W/m³.

23. The method of claim 18, further comprising pumping the hydrolyzed process mixture during the transferring of the mixture from the first reactor to the second reactor.

24. The method of claim 23, wherein at least one pump is used for the pumping.

25. The method of claim 18, wherein the mixing includes mixing the hydrolyzed process mixture outside of the first reactor and outside of the second reactor.

26. The method of claim 18, wherein the mixing includes mixing the hydrolyzed process mixture in the second reactor and in a process line through which the mixture flows from the first mixture to the second mixture.

27. The method of claim 18, wherein a first mixer is at an outlet of the first reactor and a second mixer is at an outlet of the second reactor, and
the mixing includes:
mixing with the first mixer the hydrolyzed process mixture as or after the mixture flows through the outlet of the first reactor, and
mixing with the second mixer the hydrolyzed process mixture as or after the mixture flows through the outlet of the second reactor.

28. The method of claim 18, wherein a process line is between the first reactor and the second reactor a first mixer is at an outlet of the first reactor and a second mixer is at an outlet of the second reactor, and the mixing includes:
mixing with the first mixer the hydrolyzed process mixture as or after the mixture flows through the outlet of the first reactor, and
mixing with the second mixer the hydrolyzed process mixture as or after the mixture flows through the outlet of the second reactor.

29. The method of claim 18, wherein a process line is between the first reactor and the second reactor and a mixer is in the process line,
wherein the mixing includes mixing the hydrolyzed process mixture in the process line using the mixer as the mixture flows through the process line from the first reactor to the second reactor.

30. A method comprising:
treating pulp with acid hydrolysis in in at least one reactor to form a hydrolyzed pulp, and
mixing the pulp during or after the treating to form a microcrystalline cellulose (MCC), wherein the mixing is performed with an energy dissipation in a range of 1.0×10⁶ W/m³ to 15.0×10⁶ watts per cubic meter (W/m³) and the mixing is performed in a range of 5 seconds(s) to 180 s,
wherein the MCC has a d-ratio ((d90−d10)/d50) of no greater than 6.0,
where d90 is a first micrometer size at which 90% of particles in the MCC are greater than, d10 is a second micrometer size at which 10% of the particles in the MCC are greater than, and d50 is a third micrometer size at which 50% of the particles in the MCC are greater than.

31. The method of claim 30, further comprising transferring the hydrolyzed pulp from a first reactor of the at least one reactor to a second reactor of the at least one reactor, wherein the acid hydrolysis is performed in the first reactor and in the second reactor, and
the mixing includes mixing the hydrolyzed pulp after the pulp is removed from the first reactor and before the pulp enters the second reactor.

32. The method of claim 31, wherein a first mixer is in the first reactor and a second reactor is in the second reactor, and
the mixing includes:
the first mixer mixing the hydrolyzed pulp in the first reactor wherein the first mixer dissipates energy during the mixing in a range of 1.0×10⁶ Watts per meter cubed (W/m³) to 15.0×10⁶ W/m³, and
the second mixer mixing the hydrolyzed pulp in the second reactor wherein the second mixer dissipates energy during the mixing in a range of 1.0×10⁶ W/m³ to 15.0×10⁶ W/m³.

33. The method of claim 31, wherein a first mixer is at an outlet of the first reactor and a second mixer is at an outlet of the second reactor, and
the mixing includes:
mixing with the first mixer the hydrolyzed pulp as or after the pulp flows through the outlet of the first reactor, and
mixing with the second mixer the hydrolyzed pulp as or after the pulp flows through the outlet of the second reactor.

34. The method of claim 31, wherein a process line is between the first reactor and the second reactor, a first mixer is at an outlet of the first reactor and a second mixer is at an outlet of the second reactor, and
the mixing includes:
mixing with the first mixer mixes the hydrolyzed pulp as or after the pulp flows through the outlet of the first reactor, and
mixing with the second mixer mixes the hydrolyzed pulp as or after the pulp flows through the outlet of the second reactor.
